(19) United States
(12) Patent Application Publication
(10) Pub. No.: US 2009/0202761 A1
(43) Pub. Date: Aug. 13, 2009

(54) LIGHTWEIGHT COMPONENT OF HYBRID DESIGN

(75) Inventors: Thomas Malek, Pulheim (DE); Boris Koch, Wermelskirchen (DE); Detlev Joachimi, Krefeld (DE); Stefanie Klingelhöfer, Hamburg (DE); Wolfgang Wambach, Köln (DE); Martin Klocke, Düsseldorf (DE)

Correspondence Address: NORRIS, MCLAUGHLIN & MARCUS, P.A., 875 THIRD AVE, 18TH FLOOR, NEW YORK, NY, 10022, US

(73) Assignee: LANXESS, LEVERKUSEN (DE)

(21) Appl. No.: 12/299,376

(22) PCT Filed: Apr. 23, 2007
(86) PCT No.: PCT/EP07/03520

§ 371 Date: Feb. 3, 2009

(30) Foreign Application Priority Data
May 4, 2006 (CH) 730/06

(51) Int. Cl. B29D 22/00; B62D 29/04; B29C 65/00

(52) U.S. Cl. 428/35.7; 264/249

(57) ABSTRACT

The present invention relates to lightweight components of hybrid design, also termed hybrid components or hollow-chamber lightweight components, composed of a shell-type parent body which is reinforced by means of thermoplastics and is suitable for the transmission of high mechanical loads, where particular flow aids are added to the thermoplastic in order to improve its physical properties.

The present invention relates to lightweight components of hybrid design, also termed hybrid components or hollow-chamber lightweight components, composed of a shell-type parent body which is reinforced by means of thermoplastics and is suitable for the transmission of high mechanical loads, where particular flow aids are added to the thermoplastic in order to improve its physical properties.

These lightweight components of appropriate design are used for vehicle parts, or in load-bearing elements of office machinery or of household machines or of other machinery, or in design elements for decorative purposes or the like.

A feature of lightweight components of hybrid design, hereinafter also termed hybrid components, is interlock bonding of a shell-type parent body or, respectively, hollow body, mostly composed of metal, to a plastics part introduced into this or added onto this. For the purposes of the present invention, these are also termed hollow-chamber lightweight components.

German Offenlegungsschrift 27 50 982 discloses a non-releasable connection involving two or more parts, preferably composed of metal, where the connection is composed of plastic and is produced in a mould which accepts the parts to be connected, for example by the injection-moulding process. EP-A 0 370 342 discloses a lightweight component of hybrid design composed of a shell-type parent body whose internal space has reinforcing ribs securely connected to the parent body, in that the reinforcing ribs are composed of moulded-on plastic and their connection to the parent body takes place at discrete connection sites by way of perforations in the parent body, through which the plastic extends and extends across the areas of the perforations, and a secure interlock bond is achieved. EP-A 0 995 668 supplements this principle in that the hollow-chamber lightweight component is additionally provided with a cover plate or cover shell composed of plastic. However, it is also possible to conceive of a cover plate composed of other materials, such as metal.

WO 2002/068257 discloses what are known as integrated structures composed of metal and plastic with the description of a number of fastening means in order to provide secure connection of the two components to one another. WO 2004/071741 discloses the alternative procedure, namely using two operations first to mould the plastic onto the shell-type metal part in such a way that the plastic passes through openings in the metal part and leaves flash material on the other side, where an additional conversion operation is required before this material leads to a secure interlock bond. EP 1 294 552 B1 discloses that, for the production of a hybrid component, it is possible that the metal core has been not completely, but only sectionally, overmoulded by the plastic, to give a secure interlock bond. WO 2004/011315 discloses a further variant in which the metal part provides, both above and below, openings for the secure interlock bond with the overmoulded plastic. WO 2001/38063 describes a composite plastics part composed of at least two sheet-like workpieces of different material, for example plastic and metal, or of different metals or plastics, where the workpieces have been connected to one another in their peripheral region, and the connection is composed of moulded-on thermoplastic. EP 1 223 032 A2 discloses a sheet-type lightweight component of hybrid design. U.S. Pat. No. 6,761,187 B1 discloses a hybrid component in the form of a channel or of a tube with integrated closure composed of a thermoplastic. DE 195 43 324 A1 discloses how the metal component for use as hybrid component can be prepared in order to achieve a secure interlock bond with the thermoplastic. EP 1 340 668 A2 or EP 1 300 325 A2 provides the possibility of ribbing not only within the metal part for reinforcement but also outside of the same.

It was quickly recognized that hollow-chamber lightweight components of hybrid design have excellent suitability wherever high stability, high energy absorption in the event of a crash, and weight saving are important, i.e. in the construction of motor vehicles, for example. E 0 679 565 B1 discloses the front-end of a motor vehicle with at least one rigid transverse bar which extends over most of the length of the front end, with at least one supporting part composed of plastic, cast onto the end region of the rigid transverse bar. EP 1 032 526 B1 discloses a load-bearing structure for the front module of a motor vehicle composed of a steel sheet parent body, of an unreinforced amorphous thermoplastic material, of a glass-fibre-reinforced thermoplastic, and also of a rib structure composed of, for example, polyamide. DE 100 53 840 A1 discloses a bumper system or energy-absorber element composed of oppositely arranged metal sheets and connection ribs composed of thermoplastic or of thermoset. WO 2001/40009 discloses the use of hybrid technology in brake pedals, clutch pedals or accelerator pedals of motor vehicles. EP 1 211 164 B1 in turn describes the support structure for a motor vehicle radiator arrangement, using a hybrid structure. DE 101 50 061 A1 discloses the upper transverse member in the vehicle front module of hybrid design. U.S. Pat. No. 6,688,680 B1 describes a transverse member of hybrid design in a vehicle. EP 1 380 493 A2 gives another example of a front end panel of a motor vehicle, but here the material is not injected around all of the metal part but takes the form of webs bracketing the same. Lightweight components of hybrid design can be used not only for front ends or pedals but also anywhere in the bodywork of a vehicle. By way of example, DE 100 18 186 B4 provides a solution for a vehicle door with door casing, EP 1 232 935 A1 for the actual bodywork of a vehicle and DE 102 21 709 A1 for the load-bearing elements of motor vehicles.

High-flowability thermoplastic compositions are of interest for a wide variety of shaping processes, such as injection-moulding applications. By way of example, thin-wall components in the electrical, electronics and motor vehicle industries demand low viscosities of the thermoplastic composition, to permit filling of the mould while using minimum filling pressures or clamping forces for the corresponding injection-moulding machinery. This is also relevant to the simultaneous charging of a plurality of injection-moulded components by way of a shared gating system in what are known as multi-cavity moulds. Furthermore, low-viscosity thermoplastic compositions can also often achieve shorter cycle times. Good flowabilities are also moreover specifically very important in the case of highly filled thermoplastic compositions, for example those whose glass fibre contents and/or mineral contents are above 40% by weight.

However, despite high flowability of the thermoplastic compositions, stringent mechanical requirements are placed upon the components themselves to be produced therefrom and in particular on hybrid components to be produced therefrom, and the lowering of viscosity cannot therefore be permitted to cause any impairment of mechanical properties.

There are a number of ways of obtaining high-flowability, low-viscosity thermoplastic moulding compositions.

One possibility is the use of low-viscosity polymer resins with low molecular weight as main polymers for the thermoplastic moulding compositions. However, the use of low-molecular-weight polymer resins is often attended by sacrifices in terms of mechanical properties, in particular toughness. Another factor is that the production of a low-viscosity polymer resin on an existing polymerization plant often requires complicated modification work attended by capital expenditure.

Another possibility is the use of what are known as flow aids or internal lubricants, which are an additive that can be added to the polymer resin.

These flow aids are known from the literature, e.g. Kunststoffe 2000, 9, pp. 116-118, and can by way of example be fatty acid esters of polyols, or can be amides derived from fatty acids or from amines. However, these fatty acid esters, for example pentaerythritol tetrastearate or ethylene glycol dimontanoate, have only limiting miscibility with polar thermoplastics, such as polyamides, polyalkylene terephthalates or polycarbonates. Their concentration therefore increases at the surface of the moulding, and for this reason they are also used as mould-release agents. However, particularly when relatively high concentrations are used, or on heat-ageing or in the case of polyamides also on absorption of moisture, they can migrate to the surface of these mouldings, where their concentration increases. By way of example, this can lead to problems in relation to paint adhesion or metal adhesion in coated mouldings.

As an alternative to these surfactant flow aids, internal flow aids can be used, these being compatible with the polymer resins. Examples of materials suitable for this purpose are low-molecular-weight compounds or branched, highly branched or dendritic polymers, with polarity similar to that of the polymer resin. These highly branched or dendritic systems are known from the literature, and can by way of example be based on branched polyesters, polyamides, polyesteramides, polyethers or polyamines, as described in Kunststoffe 2001, 91, pp. 179-190, or in Advances in Polymer Science 1999, 143 (Branched Polymers II), pp. 1-34.

In principle, the flowability of polyamides can be improved via addition of highly branched polymers having rigid aromatic units, via addition of polymers based on aromatics or via addition of phenols, bisphenols and similar low-molecular-weight additives.

If, however, the intention is to influence not only the flowability of the moulding compositions but at the same time the modulus of elasticity and thus the stiffness of mouldings, in particular for use in hybrid components, the flow improvers of the prior art rapidly reach their limits. Nor is the desired result achieved here by using other copolymers based on ethene and on acrylates or methacrylates, in the thermoplastics to be used.

The object of the present invention consisted in producing hollow-chamber lightweight components of hybrid design which firstly have the advantages known from the prior art, such as high buckling resistance, high torsional stability, and relatively high strength, but which moreover feature relatively low weight and relatively low mould temperatures during production, where the viscosity of the polycondensate compositions is lowered via use of additives in the polymer melt, without any need here to accept the sort of losses in properties such as impact resistance and hydrolysis resistance that occur when low-viscosity linear polymer resins or additives known from the literature are used. In terms of stiffness and ultimate tensile strength, the intention was that ideally there be no significant difference from the polycondensate compositions not using additives, thus permitting problem-free replacement of the materials for plastics designs based on, for example, polyamide, and thus providing optimized use in hybrid components.
The object is achieved in that the present invention provides lightweight components composed of a shell-type parent body whose external and/or internal space has reinforcing structures securely connected to the parent body and composed of moulded-on thermoplastics, and having connection to the parent body at discrete connection sites, characterized in that polymer moulding compositions are used comprising
   A) from 99.99 to 10 parts by weight, preferably from 99.5 to 40 parts by weight, particularly preferably
      from 99.0 to 55 parts by weight, of at least one semicrystalline thermoplastic polymer and
   B) from 0.01 to 50 parts by weight, preferably from 0.25 to 20 parts by weight, particularly preferably from 1.0 to 15 parts by weight
   B1) of at least one copolymer composed of at least one olefin, preferably one α-olefin, with at least one methacrylate or acrylate of an aliphatic alcohol, preferably of an aliphatic alcohol having from 1 to 30 carbon atoms, where the MFI of the copolymer B1) is not less than 100 g/10 min, preferably not less than 150 g/10 min, or
   B2) of at least one highly branched or hyperbranched polycarbonate with an OH number of from 1 to 600 mg KOH/g of polycarbonate (to DIN 53240, Part 2), or
   B3) of at least one highly branched or hyperbranched polyester of AₓB_{y} type, where x is at least 1.1 and y is at least 2.1, or
a mixture of B1) with B2) or of B2) with B3) or of B1) with B3) or of B1) with B2) and with B3), in each case with A).

In one preferred embodiment, the connection of the moulded-on thermoplastic to the parent body takes place at discrete connection sites by way of perforations in the parent body, where the plastic (thermoplastic) extends through these and extends over the area of the perforations, thus achieving a secure interlock bond. According to the invention, this procedure can be realized in one, two, three or more steps. The shell-type parent body preferably has a U shape, but can also have another shape in the case of motor vehicle doors. The design of the shell-type parent body is however in essence determined via the shape of the moulding to be produced. It is preferable to use a shell-type parent body composed of metal, particularly preferably of iron, steel, brass, aluminium, magnesium or titanium. However, the shell-type parent body itself can also be composed of a thermoplastic, and the thermoplastics used here can be the same as those described for component A) in the present application.

The processing of the polymer moulding compositions to give the inventive lightweight components of hybrid design takes place via shaping processes for thermoplastics, preferably via injection moulding, melt extrusion, compression moulding, stamping or blow moulding. In principle, the advantageous effects to be achieved are apparent with thermoplastics of any type. A list of the thermoplastics to be used as component A) is found by way of example in Kunststoff-Taschenbuch [Plastics Handbook] (Ed. Saechtling), 1989 edition, which also mentions sources. Processes for the production of these thermoplastics are known per se to the person skilled in the art. The effects to be achieved are likewise apparent in all of the variations disclosed in the prior art cited above of the use of hybrid technology, irrespective of whether the plastics part encapsulates the metal part completely or, as in the case of EP 1 380 493 A2, merely forms a web around it, and irrespective of whether the plastics part is subsequently incorporated by adhesion or connected by way of example by a laser to the metal part, or whether, as in WO 2004/071741, the plastics part and the metal part obtain the secure interlock bond in an additional operation.

Preferred semicrystalline thermoplastic polymers (thermoplastics) to be used as component A) for the inventive lightweight components in hybrid technology are those selected from the group of the polyamides, vinylaromatic polymers, ASA polymers, ABS polymers, SAN polymers, POM, PPE, polyarylene ether sulphones, polypropylene (PP) or their blends, preference being given here to polyamide, polyester, polypropylene and polycarbonates or blends comprising polyamide, polyester or polycarbonates as essential constituent.

It is particularly preferable that the component A) used in the moulding compositions to be processed comprises at least one polymer from the series of polyester, polycarbonate, polypropylene or polyamide or blends of these thermoplastics with the abovementioned materials.

Polyamides to be used with particular preference according to the invention as component A) are semicrystalline polyamides, which can be prepared starting from diamines and dicarboxylic acids and/or from lactams having at least five ring members, or from corresponding amino acids. Starting materials that can be used for this purpose are aliphatic and/or aromatic dicarboxylic acids, such as adipic acid, 2,2,4- and 2,4,4-trimethyladipic acid, azelaic acid, sebacic acid, isophthalic acid, terephthalic acid, and aliphatic and/or aromatic diamines, e.g. tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, e.g. aminocaproic acid, and the corresponding lactams. Copolyamides composed of a plurality of the monomers mentioned are included.

Polyamides preferred according to the invention are prepared from caprolactams, very particularly preferably from ε-caprolactam, and also most of the compounding materials based on PA6, on PA66, and on other aliphatic and/or aromatic polyamides and, respectively, copolyamides, where there are from 3 to 11 methylene groups for every polyamide group in the polymer chain.

Semicrystalline polyamides to be used according to the invention as component A) can also be used in a mixture with other polyamides and/or with further polymers.

Conventional additives, e.g. mould-release agents, stabilizers and/or flow aids, can be admixed in the melt with the polyamides or applied to the surface.

According to the invention, another particularly preferred component A) to be used is polyesters, these being polyesters based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety.

Polyalkylene terephthalates of this type are known and are described in the literature. Their main chain comprises an aromatic ring which derives from the aromatic dicarboxylic acid. There may also be substitution in the aromatic ring, e.g. by halogen, such as chlorine or bromine, or by C₁-C₄-alkyl groups, such as methyl, ethyl, iso- or n-propyl, or n-, iso- or tert-butyl groups.

These polyalkylene terephthalates may be prepared by reacting aromatic dicarboxylic acids, or their esters or other ester-forming derivatives, with aliphatic dihydroxy compounds in a known manner.

Preferred dicarboxylic acids that may be mentioned are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Among the aliphatic di-hydroxy compounds, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Polyesters of component A) whose use is very particularly preferred are polyalkylene terephthalates derived from alkanediols having from 2 to 6 carbon atoms. Among these, particular preference is given to polyethylene terephthalate, polypropylene terephthalate and polybutylene terephthalate, and mixtures of these. Preference is also given to PET and/or PBT which comprise, as other monomer units, up to 1% by weight, preferably up to 0.75% by weight, of 1,6-hexanediol and/or 2-methyl-1,5-pentanediol.

The viscosity number of polyesters whose use is preferred according to the invention as component A) is generally in the range from 50 to 220, preferably from 8 to 160 (measured in 0.5% strength by weight solution in a phenol/o-dichlorobenzene mixture in a ratio by weight of 1:1 at 25° C.) in accordance with ISO 1628.

Particular preference is given to polyesters whose carboxy end group content is up to 100 meq/kg of polyester, preferably up to 50 meq/kg of polyester and in particular up to 40 meq/kg of polyester. Polyesters of this type may be prepared, for example, by the process of DE-A 44 01 055. The carboxy end group content is usually determined by titration methods (e.g. potentiometry).

If polyester mixtures are used as component A), the moulding compositions comprise a mixture composed of polyesters which differ from PBT, an example being polyethylene terephthalate (PET). The content by way of example of the polyethylene terephthalate is preferably up to 50% by weight in the mixture, in particular from 10 to 35% by weight, based on 100% by weight of A).

It is also advantageous to use recycled materials, such as recycled PA materials or recycled PET materials (also termed scrap PET), if appropriate mixed with polyalkylene terephthalates, such as PBT.

Recycled materials are generally:
1) those known as post-industrial recycled materials: these are production wastes during polycondensation or during processing, e.g. sprues from injection moulding, start-up material from injection moulding or extrusion, or edge trims from extruded sheets or foils.
2) post-consumer recycled materials: these are plastic items which are collected and treated after utilization by the end consumer. Blow-moulded PET bottles for mineral water, soft drinks and juices are easily the predominant items in terms of quantity.

Both types of recycled material may be used either as ground material or in the form of pellets. In the latter case, the crude recycled materials are separated and purified and then melted and pelletized using an extruder. This usually facilitates handling and free flow, and metering for further steps in processing.

The recycled materials used may be either pelletized or in the form of regrind. The edge length should not be more than 10 mm, preferably less than 8 mm.

Because polyesters undergo hydrolytic cleavage during processing (due to traces of moisture) it is advisable to predry the recycled material. The residual moisture content after drying is preferably <0.2%, in particular <0.05%.

Another group that may be mentioned of polyesters whose use is preferred for component A) is that of fully aromatic polyesters derived from aromatic dicarboxylic acids and aromatic dihydroxy compounds.

Suitable aromatic dicarboxylic acids are the compounds previously mentioned for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the general formula

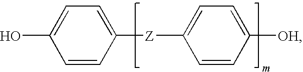

where
Z is an alkylene or cycloalkylene group having up to 8 carbon atoms, an arylene group having up to 12 carbon atoms, a carbonyl group, a sulphonyl group, an oxygen or sulphur atom, or a chemical bond, and where
m is from 0 to 2.

The phenylene groups of the compounds may also have substitution by C₁-C₆-alkyl or -alkoxy groups and fluorine, chlorine or bromine.

Examples of parent compounds for these compounds are dihydroxybiphenyl, di(hydroxyphenyl)alkane, di(hydroxyphenyl)cycloalkane, di(hydroxyphenyl)sulphide, di(hydroxyphenyl)ether, di(hydroxyphenyl) ketone, di(hydroxyphenyl) sulphoxide, α,α′-di(hydroxyphenyl)dialkylbenzene, di(hydroxyphenyl) sulphone, di(hydroxybenzoyl)benzene, resorcinol, and hydroquinone, and also the ring-alkylated and ring-halogenated derivatives of these.

Among these, preference is given to 4,4′-dihydroxybiphenyl, 2,4-di(4′-hydroxyphenyl)-2-methylbutane, α,α′-di(4-hydroxyphenyl)-p-diisopropylbenzene, 2,2-di(3′-methyl-4′-hydroxyphenyl)propane, and 2,2-di(3′-chloro-4′-hydroxyphenyl)propane, and in particular to 2,2-di(4′-hydroxyphenyl)propane, 2,2-di(3′,5-dichlorodihydroxyphenyl)propane, 1,1-di(4′-hydroxyphenyl)cyclohexane, 3,4′-dihydroxybenzophenone, 4,4′-dihydroxydiphenyl sulphone and 2,2-di(3′,5′-dimethyl-4′-hydroxyphenyl)propane and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known and are described in the literature, e.g. in U.S. Pat. No. 3,651,014. Corresponding products are also available commercially, e.g. Hytrel® (DuPont).

According to the invention, materials whose use is preferred as polyesters and therefore likewise as component A) also include halogen-free polycarbonates. Examples of suitable halogen-free polycarbonates are those based on diphenols of the general formula

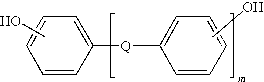

where
Q is a single bond, a C₁-C₈-alkylene, C₂-C₃-alkylidene, C₃-C₆-cycloalkylidene, C₆-C₁₂-arylene group, or —O—, —S— or —SO₂—, and m is a whole number from 0 to 2.

The phenylene radicals of the diphenols may also have substituents, such as C₁-C₆-alkyl or C₁-C₆-alkoxy.

Examples of preferred diphenols of the formula are hydroquinone, resorcinol, 4,4′-dihydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as component A, and preference is given to the copolycarbonates of bisphenol A, as well as to bisphenol A homopolymer.

Suitable polycarbonates may be branched in a known manner, specifically and preferably by incorporating from 0.05 to 2.0 mol %, based on the total of the diphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to an average molar mass M, (weight-average) of from 10 000 to 200 000 g/mol, preferably from 20 000 to 80 000 g/mol.

The diphenols of the general formula are known or can be prepared by known processes.

The polycarbonates may, for example, be prepared by reacting the diphenols with phosgene in the interfacial process, or with phosgene in the homogeneous-phase process (known as the pyridine process), and in each case the desired molecular weight may be achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates composed of halogen-free diphenols, of halogen-free chain terminators and, if used, halogen-free branching agents, where the content of subordinate amounts at the ppm level of hydrolyzable chlorine, resulting, for example, from the preparation of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable components A) that may be mentioned are amorphous polyester carbonates, where during the preparation process phosgene has been replaced by aromatic dicarboxylic acid units, such as isophthalic acid and/or terephthalic acid units. Reference may be made at this point to EP-A 711 810 for further details.

EP-A 365 916 describes other suitable copolycarbonates having cycloalkyl radicals as monomer units.

It is also possible for bisphenol A to be replaced by bisphenol TMC. Polycarbonates of this type are obtainable from Bayer AG with the trademark APEC HT®.

However, preference is given according to the invention to the use of the polyamides or polyesters described above as component A).

The moulding compositions to be used according to the invention can comprise, as component B), B1) copolymers, preferably random copolymers composed of at least one olefin, preferably α-olefin, and of at least one methacrylate or acrylate of an aliphatic alcohol, where the MFI of the copolymer B) is not less than 100 g/10 min, preferably 150 g/10 min, particularly preferably 300 g/10 min. In one preferred embodiment, the copolymer B1) is composed of less than 4% by weight, particularly preferably less than 1.5% by weight and very particularly preferably 0% by weight, of monomer units which contain further reactive functional groups selected from the group comprising epoxides, oxetanes, anhydrides, imides, aziridines, furans, acids, amines, oxazolines.

Olefins, preferably α-olefins, suitable as constituent of the copolymers B1) preferably have from 2 to 10 carbon atoms and can be unsubstituted or can have substitution by one or more aliphatic, cycloaliphatic or aromatic groups.

Preferred olefins are those selected from the group consisting of ethene, propene, 1-butene, 1-pentene, 1-hexene, 1-octene, 3-methyl-1-pentene. Particularly preferred olefins are ethene and propene, and ethene is particularly preferred.

Mixtures of the olefins described are also suitable.

In an embodiment to which further preference is given, the further reactive functional groups of the copolymer B1), selected from the group consisting of epoxides, oxetanes, anhydrides, imides, aziridines, furans, acids, amines, oxazolines, are introduced exclusively by way of the olefins into the copolymer B1).

The content of the olefin in the copolymer B1) is from 50 to 90% by weight, preferably from 55 to 75% by weight.

The copolymer B1) is further defined via the second constituent alongside the olefin. A suitable second constituent is alkyl esters or arylalkyl esters of acrylic acid or methacrylic acid whose alkyl or arylalkyl group is formed from 1 to 30 carbon atoms. The alkyl or arylalkyl group here can be linear or branched, and also can contain cycloaliphatic or aromatic groups, and alongside this can also have substitution by one or more ether or thioether functions. Other suitable methacrylates or acrylates in this connection are those synthesized from an alcohol component based on oligoethylene glycol or on oligopropylene glycol having only one hydroxy group and at most 30 carbon atoms.

By way of example, the alkyl group or arylalkyl group of the methacrylate or acrylate can have been selected from the group consisting of methyl, ethyl, n-propyl, isopropyl, n-butyl, isobutyl, tert-butyl, sec-butyl, 1-pentyl, 1-hexyl, 2-hexyl, 3-hexyl, 1-heptyl, 3-heptyl, 1-octyl, 1-(2-ethyl)hexyl, 1-nonyl, 1-decyl, 1-dodecyl, 1-lauryl or 1-octadecyl. Preference is given to alkyl groups or arylalkyl groups having from 6 to 20 carbon atoms. Preference is particularly also given to branched alkyl groups which have the same number of carbon atoms as linear alkyl groups but give a lower glass transition temperature T_{G}.

Particular preference according to the invention is given to copolymers B1) in which the olefin is copolymerized with 2-ethylhexyl acrylate. Mixtures of the acrylates or methacrylates described are also suitable.

It is preferable here to use more than 60% by weight, particularly preferably more than 90% by weight and very particularly preferably 100% by weight, of 2-ethylhexyl acrylate, based on the total amount of acrylate and methacrylate in copolymer B1).

In an embodiment to which further preference is given, the further reactive functional groups selected from the group consisting of epoxides, oxetanes, anhydrides, imides, aziridines, furans, acids, amines, oxazolines in the copolymer B1) are introduced exclusively by way of the acrylate or methacrylate into the copolymer B1).

The content of the acrylate or methacrylate in the copolymer B1) is from 10 to 50% by weight, preferably from 25 to 45% by weight.

Another feature of suitable copolymers B1), alongside their constitution, is low molecular weight. Accordingly, copolymers B1) suitable for the inventive moulding compositions are only those whose MFI value (Melt Flow Index) measured at 190° C. and with a load of 2.16 kg is at least 100 g/10 min, preferably at least 150 g/10 min, particularly preferably at least 300 g/10 min.

By way of example, copolymers suitable as component B1) can be those selected from the group of materials supplied by Atofina with the trade mark Lotryl® EH, these usually being used as hot-melt adhesives.

The inventive moulding compositions can comprise, as component B) and as alternative to B1), from 0.01 to 50% by weight, preferably from 0.5 to 20% by weight and in particular from 0.7 to 10% by weight, of B2) at least one highly branched or hyperbranched polycarbonate with an OH number of from 1 to 600 mg KOH/g of polycarbonate, preferably from 10 to 550 mg KOH/g of polycarbonate and in particular from 50 to 550 mg KOH/g of polycarbonate (to DIN 53240, Part 2) or of at least one hyperbranched polyester as component B3) or a mixture of B1) with B2) or of B2) with B3) or of B1) with B3) or a mixture of B1) with B2) and with B3).

For the purposes of this invention, hyperbranched polycarbonates B2) are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”.

Component B2) preferably has a number-average molar mass Mₙ of from 100 to 15 000 g/mol, preferably from 200 to 12 000 g/mol, and in particular from 500 to 10 000 g/mol (GPC, PMMA standard).

The glass transition temperature Tg is in particular from −80 to +140° C., preferably from −60 to 120° C. (according to DSC, DIN 53765).

In particular, the viscosity (mPas) at 23° C. (to DIN 53019) is from 50 to 200 000, in particular from 100 to 150 000, and very particularly preferably from 200 to 100 000.

Component B2) is preferably obtainable via a process which comprises at least the following steps:
a) reaction of at least one organic carbonate (A) of the general formula RO[(CO)]ₙOR with at least one aliphatic, aliphatic/aromatic or aromatic alcohol (B) which has at least 3 OH groups, with elimination of alcohols ROH to give one or more condensates (K), where each R, independently of the others, is a straight-chain or branched aliphatic, aromatic/aliphatic or aromatic hydrocarbon radical having from 1 to 20 carbon atoms, and where the radicals R may also have bonding to one another to form a ring, and n is a whole number from 1 to 5, or
ab) reaction of phosgene, diphosgene, or triphosgene with alcohol (B) mentioned under a), with elimination of hydrogen chloride
b) intermolecular reaction of the condensates (K) to give a highly functional, highly branched, or highly functional, hyperbranched polycarbonate, where the quantitative proportion of the OH groups to the carbonates in the reaction mixture is selected in such a way that the condensates (K) have an average of either one carbonate group and more than one OH group or one OH group and more than one carbonate group.

Phosgene, diphosgene, or triphosgene may be used as starting material, but preference is given to organic carbonates.

Each of the radicals R of the organic carbonates (A) used as starting material and having the general formula RO(CO)OR is, independently of the others, a straight-chain or branched aliphatic, aromatic/aliphatic or aromatic hydrocarbon radical having from 1 to 20 carbon atoms. The two radicals R may also have bonding to one another to form a ring. The radical is preferably an aliphatic hydrocarbon radical, and particularly preferably a straight-chain or branched alkyl radical having from 1 to 5 carbon atoms, or a substituted or unsubstituted phenyl radical.

In particular, use is made of simple carbonates of the formula RO(CO)OR; n is preferably from 1 to 3, in particular 1.

By way of example, dialkyl or diaryl carbonates may be prepared from the reaction of aliphatic, araliphatic, or aromatic alcohols, preferably monoalcohols, with phosgene. They may also be prepared by way of oxidative carbonylation of the alcohols or phenols by means of CO in the presence of noble metals, oxygen, or NO_{X}. In relation to preparation methods for diaryl or dialkyl carbonates, see also “Ullmann's Encyclopedia of Industrial Chemistry”, 6th edition, 2000 Electronic Release, Verlag Wiley-VCH.

Examples of suitable carbonates comprise aliphatic, aromatic/aliphatic or aromatic carbonates, such as ethylene carbonate, propylene 1,2- or 1,3-carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

Examples of carbonates where n is greater than 1 comprise dialkyl dicarbonates, such as di(tert-butyl) dicarbonate, or dialkyl tricarbonates, such as di(tert-butyl) tricarbonate.

It is preferable to use aliphatic carbonates, in particular those in which the radicals comprise from 1 to 5 carbon atoms, e.g. dimethyl carbonate, diethyl carbonate, dipropyl carbonate, dibutyl carbonate, or diisobutyl carbonate.

The organic carbonates are reacted with at least one aliphatic alcohol (B) which has at least 30H groups, or with mixtures of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl) isocyanurate, tris(hydroxyethyl) isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, or sugars, e.g. glucose, trihydric or higher polyhydric polyetherols based on trihydric or higher polyhydric alcohols and ethylene oxide, propylene oxide, or butylene oxide, or polyesterols. Particular preference is given here to glycerol, trimethylolethane, trimethylolpropane, 1,2,4-butanetriol, pentaerythritol, and also their polyetherols based on ethylene oxide or propylene oxide.

These polyhydric alcohols may also be used in a mixture with dihydric alcohols (B′), with the proviso that the average total OH functionality of all of the alcohols used is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxyphenyl, bis(4-bis(hydroxyphenyl) sulphide, bis(4-hydroxyphenyl) sulphone, bis(hydroxymethyl)benzene, bis(hydroxymethyl)toluene, bis(p-hydroxyphenyl)methane, bis(p-hydroxyphenyl)ethane, 2,2-bis(hydroxyphenyl)propane, 1,1-bis(p-hydroxyphenyl)cyclohexane, dihydroxybenzophenone, dihydric polyether polyols based on ethylene oxide, propylene oxide, butylene oxide, or mixtures of these, polytetrahydrofuran, polycaprolactone, or polyesterols based on diols and dicarboxylic acids.

The diols serve for fine adjustment of the properties of the polycarbonate. If use is made of dihydric alcohols, the ratio of dihydric alcohols B′), to the at least trihydric alcohols (B) is set by the person skilled in the art and depends on the desired properties of the polycarbonate. The amount of the alcohol(s) (B′) is generally from 0 to 39.9 mol %, based on the total amount of all of the alcohols (B) and (B′) taken together. The amount is preferably from 0 to 35 mol %, particularly preferably from 0 to 25 mol %, and very particularly preferably from 0 to 10 mol %.

The reaction of phosgene, diphosgene, or triphosgene with the alcohol or alcohol mixture generally takes place with elimination of hydrogen chloride, and the reaction of the carbonates with the alcohol or alcohol mixture to give the highly functional highly branched polycarbonate takes place with elimination of the monofunctional alcohol or phenol from the carbonate molecule.

The highly functional highly branched polycarbonates have termination by hydroxy groups and/or by carbonate groups after their preparation, i.e. with no further modification. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a highly functional polycarbonate is a product which, besides the carbonate groups which form the polymer skeleton, further has at least three, preferably at least six, more preferably at least ten, terminal or pendant functional groups. The functional groups are carbonate groups and/or OH groups. There is in principle no upper restriction on the number of the terminal or pendant functional groups, but products having a very high number of functional groups can have undesired properties, such as high viscosity or poor solubility. The highly functional polycarbonates of the present invention mostly have not more than 500 terminal or pendant functional groups, preferably not more than 100 terminal or pendant functional groups.

When preparing the highly functional polycarbonates B2), it is necessary to adjust the ratio of the compounds comprising OH groups to phosgene or carbonate in such a way that the simplest resultant condensate (hereinafter termed condensate (K)) comprises an average of either one carbonate group or carbamoyl group and more than one OH group or one OH group and more than one carbonate group or carbamoyl group. The simplest structure of the condensate (K) composed of a carbonate (A) and a di- or polyalcohol (B) here results in the arrangement XYₙ or YₙX, where X is a carbonate group, Y is a hydroxy group, and n is generally a number from 1 to 6, preferably from 1 to 4, particularly preferably from 1 to 3. The reactive group which is the single resultant group here is generally termed “focal group” below.

By way of example, if during the preparation of the simplest condensate (K) from a carbonate and a dihydric alcohol the reaction ratio is 1:1, the average result is a molecule of XY type, illustrated by the general formula I.

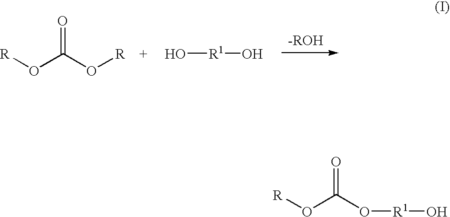

During the preparation of the condensate (K) from a carbonate and a trihydric alcohol with a reaction ratio of 1:1, the average result is a molecule of XY₂ type, illustrated by the general formula II. A carbonate group is focal group here.

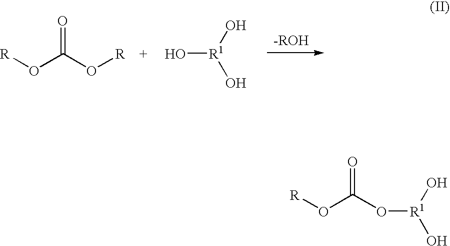

During the preparation of the condensate (K) from a carbonate and a tetrahydric alcohol, likewise with the reaction ratio 1:1, the average result is a molecule of XY₃ type, illustrated by the general formula III. A carbonate group is focal group here.

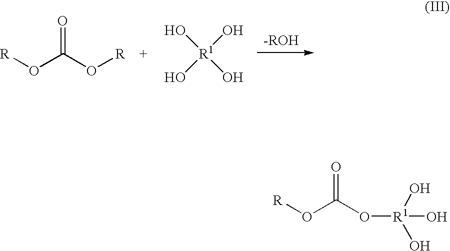

R in the formulae (I) to (III) has the definition given above, and R¹ is an aliphatic or aromatic radical.

The condensate (K) may, by way of example, also be prepared from a carbonate and a trihydric alcohol, as illustrated by the general formula (IV), the molar reaction ratio being 2:1. Here, the average result is a molecule of X₂Y type, an OH group being focal group here. In formula (IV), R and R¹ are as defined in formulae (I) to (III).

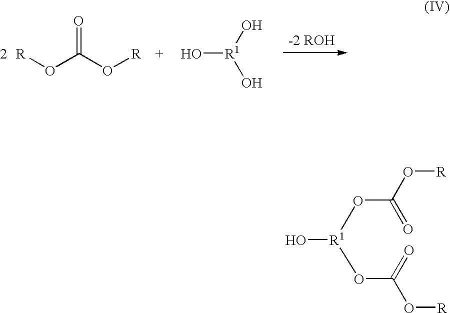

If difunctional compounds, e.g. a dicarbonate or a diol, are also added to the components, this extends the chains, as illustrated by way of example in the general formula (V). The average result is again a molecule of XY₂ type, a carbonate group being focal group.

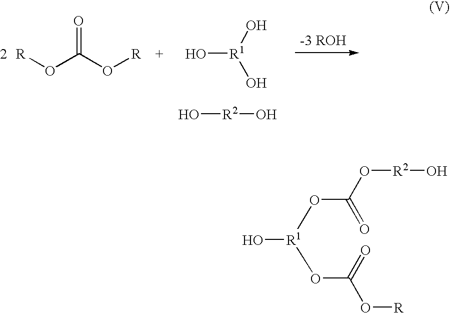

In formula (V), R² is an organic, preferably aliphatic radical, and R and R¹ are as defined above.

It is also possible to use two or more condensates (K) for the synthesis. Here, firstly two or more alcohols or two or more carbonates may be used. Furthermore, mixtures of various condensates of different structure can be obtained via the selection of the ratio of the alcohols used and of the carbonates or the phosgenes. This may be illustrated taking the example of the reaction of a carbonate with a trihydric alcohol. If the starting products are reacted in a ratio of 1:1, as shown in (II), the result is an XY₂ molecule. If the starting products are reacted in a ratio of 2:1, as shown in (IV), the result is an X₂Y molecule. If the ratio is from 1:1 to 2:1, the result is a mixture of XY₂ and X₂Y molecules.

According to the invention, the simple condensates (K) described by way of example in the formulae (I) to (V) preferentially react intermolecularly to form highly functional polycondensates, hereinafter termed polycondensates (P). The reaction to give the condensate (K) and to give the polycondensate (P) usually takes place at a temperature of from 0 to 250° C., preferably from 60 to 160° C., in bulk or in solution.

Use may generally be made here of any of the solvents which are inert with respect to the respective starting materials. Preference is given to use of organic solvents, e.g. decane, dodecane, benzene, toluene, chlorobenzene, xylene, dimethylformamide, dimethylacetamide, or solvent naphtha.

In one embodiment, the condensation reaction is carried out in bulk. To accelerate the reaction, the phenol or the monohydric alcohol ROH liberated during the reaction can be removed by distillation from the reaction equilibrium if appropriate at reduced pressure.

If removal by distillation is intended, it is generally advisable to use those carbonates which liberate alcohols ROH with a boiling point below 140° C. during the reaction.

Catalysts or catalyst mixtures may also be added to accelerate the reaction. Suitable catalysts are compounds which catalyze esterification or transesterification reactions, e.g. alkali metal hydroxides, alkali metal carbonates, alkali metal hydrogencarbonates, preferably of sodium, of potassium, or of cesium, tertiary amines, guanidines, ammonium compounds, phosphonium compounds, organoaluminium, organotin, organozinc, organotitanium, organozirconium, or organobismuth compounds, or else what are known as double metal cyanide (DMC) catalysts, e.g. as described in DE-A 10138216 or DE-A 10147712.

It is preferable to use potassium hydroxide, potassium carbonate, potassium hydrogencarbonate, diazabicyclooctane (DABCO), diazabicyclononene (DBN), diazabicycloundecene (DBU), imidazoles, such as imidazole, 1-methylimidazole, or 1,2-dimethylimidazole, titanium tetrabutoxide, titanium tetraisopropoxide, dibutyltin oxide, dibutyltin dilaurate, stannous dioctoate, zirconium acetylacetonate, or mixtures thereof.

The amount of catalyst generally added is from 50 to 10 000 ppm by weight, preferably from 100 to 5000 ppm by weight, based on the amount of the alcohol mixture or alcohol used.

It is also possible to control the intermolecular polycondensation reaction via addition of the suitable catalyst or else via selection of a suitable temperature. The average molecular weight of the polymer (P) may moreover be adjusted by way of the composition of the starting components and by way of the residence time.

The condensates (K) and the polycondensates (P) prepared at an elevated temperature are usually stable at room temperature for a relatively long period.

The nature of the condensates (K) permits polycondensates (P) with different structures to result from the condensation reaction, these having branching but no crosslinking. Furthermore, in the ideal case, the polycondensates (P) have either one carbonate group as focal group and more than two OH groups or else one OH group as focal group and more than two carbonate groups. The number of the reactive groups here is the result of the nature of the condensates (K) used and the degree of polycondensation.

By way of example, a condensate (K) according to the general formula (II) can react via triple intermolecular condensation to give two different polycondensates (P), represented in the general formulae (VI) and (VII).

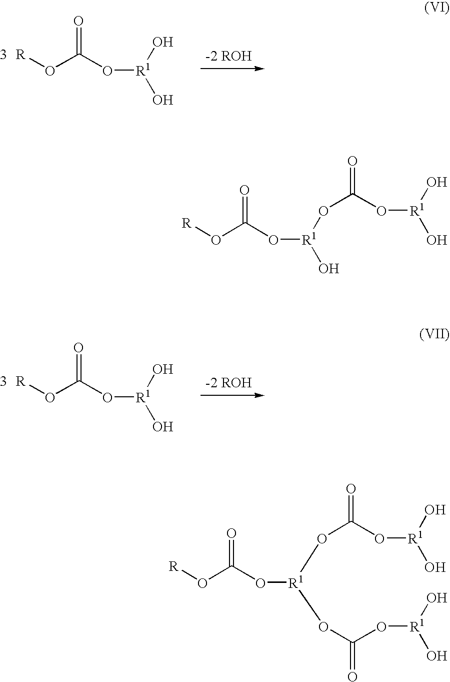

In formula (VI) and (VII), R and R¹ are as defined above.

There are various ways of terminating the intermolecular polycondensation reaction. By way of example, the temperature may be lowered to a range where the reaction stops and the product (K) or the polycondensate (P) is storage-stable.

It is also possible to deactivate the catalyst, for example in the case of basic catalysts via addition of Lewis acids or proton acids.

In another embodiment, as soon as the intermolecular reaction of the condensate (K) has produced a polycondensate (P) with the desired degree of polycondensation, a product having groups reactive toward the focal group of (P) may be added to the product (P) to terminate the reaction. In the case of a carbonate group as focal group, by way of example, a mono-, di-, or polyamine may therefore be added. In the case of a hydroxy group as focal group, by way of example, a mono-, di-, or polyisocyanate, or a compound comprising epoxy groups, or an acid derivative which reacts with OH groups, can be added to the product (P).

The highly functional polycarbonates are mostly prepared in a pressure range from 0.1 mbar to 20 bar, preferably at from 1 mbar to 5 bar, in reactors or reactor cascades which are operated batchwise, semicontinuously, or continuously.

The inventive products can be further processed without further purification after their preparation by virtue of the abovementioned adjustment of the reaction conditions and, if appropriate, by virtue of the selection of the suitable solvent.

In another preferred embodiment, the product is stripped, i.e. freed from low-molecular-weight, volatile compounds. For this, once the desired degree of conversion has been reached the catalyst may optionally be deactivated and the low-molecular-weight volatile constituents, e.g. monoalcohols, phenols, carbonates, hydrogen chloride, or volatile oligomeric or cyclic compounds, can be removed by distillation, if appropriate with introduction of a gas, preferably nitrogen, carbon dioxide, or air, if appropriate at reduced pressure.

In another preferred embodiment, the polycarbonates may comprise other functional groups besides the functional groups present at this stage by virtue of the reaction. The functionalization may take place during the process to increase molecular weight, or else subsequently, i.e. after completion of the actual polycondensation.

If, prior to or during the process to increase molecular weight, components are added which have other functional groups or functional elements besides hydroxy or carbonate groups, the result is a polycarbonate polymer with randomly distributed functionalities other than the carbonate or hydroxy groups.

Effects of this type can, by way of example, be achieved via addition, during the polycondensation, of compounds which bear other functional groups or functional elements, such as mercapto groups, primary, secondary or tertiary amino groups, ether groups, derivatives of carboxylic acids, derivatives of sulphonic acids, derivatives of phosphonic acids, silane groups, siloxane groups, aryl radicals, or long-chain alkyl radicals, besides hydroxy groups, carbonate groups or carbamoyl groups. Examples of compounds which may be used for modification by means of carbamate groups are ethanolamine, propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxyethyl)aminomethane, ethylenediamine, propylenediamine, hexamethylenediamine or isophoronediamine.

An example of a compound which can be used for modification with mercapto groups is mercaptoethanol. By way of example, tertiary amino groups can be produced via incorporation of N-methyldiethanolamine, N-methyldipropanolamine or N,N-dimethylethanolamine. By way of example, ether groups may be generated via co-condensation of dihydric or higher polyhydric polyetherols. Long-chain alkyl radicals can be introduced via reaction with long-chain alkanediols, and reaction with alkyl or aryl diisocyanates generates polycarbonates having alkyl, aryl, and urethane groups, or urea groups.

Ester groups can be produced via addition of dicarboxylic acids, tricarboxylic acids, or, for example, dimethyl terephthalate, or tricarboxylic esters.

Subsequent functionalization can be achieved by using an additional step of the process to react the resultant highly functional, highly branched, or highly functional hyperbranched polycarbonate with a suitable functionalizing reagent which can react with the OH and/or carbonate groups or carbamoyl groups of the polycarbonate.

By way of example, highly functional highly branched, or highly functional hyperbranched polycarbonates comprising hydroxy groups can be modified via addition of molecules comprising acid groups or isocyanate groups. By way of example, polycarbonates comprising acid groups can be obtained via reaction with compounds comprising anhydride groups.

Highly functional polycarbonates comprising hydroxy groups may moreover also be converted into highly functional polycarbonate polyether polyols via reaction with alkylene oxides, e.g. ethylene oxide, propylene oxide, or butylene oxide.

The moulding compositions to be used for the production of the inventive hybrid-based lightweight components can comprise, as component B3), at least one hyperbranched polyester of AₓB_{y} type, where

x is at least 1.1, preferably at least 1.3, in particular at least 2 and
y is at least 2.1, preferably at least 2.5, in particular at least 3.

Use may also be made of mixtures as units A and/or B, of course.

An AₓB_{y}-type polyester is a condensate composed of an x-functional molecule A and a γ-functional molecule B. By way of example, mention may be made of a polyester composed of adipic acid as molecule A (x=2) and glycerol as molecule B (y=3).

For the purposes of this invention, hyperbranched polyesters B3) are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%. “Dendrimeric” in the context of the present invention means that the degree of branching is from 99.9 to 100%. See H. Frey et al., Acta Polym. 1997, 48, 30 for the definition of “degree of branching”.

Component B3) preferably has a molecular weight of from 300 to 30 000 g/mol, in particular from 400 to 25 000 g/mol, and very particularly from 500 to 20 000 g/mol, determined by means of GPC, PMMA standard, dimethylacetamide eluent.

B3) preferably has an OH number of from 0 to 600 mg KOH/g of polyester, preferably from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

The Tg is preferably from −50° C. to 140° C., and in particular from −50 to 100° C. (by means of DSC, to DIN 53765).

Preference is particularly given to those components B3) in which at least one OH or COOH number is greater than 0, preferably greater than 0.1, and in particular greater than 0.5.

The component B3) is obtainable via the processes described below, for example by reacting
(m) one or more dicarboxylic acids or one or more derivatives of the same with one or more at least trihydric alcohols
or
(n) one or more tricarboxylic acids or higher polycarboxylic acids or one or more derivatives of the same with one or more diols in the presence of a solvent and optionally in the presence of an inorganic, organometallic, or low-molecular-weight organic catalyst, or of an enzyme. The reaction in solvent is the preferred preparation method.

Highly functional hyperbranched polyesters B3) have molecular and structural non-uniformity. Their molecular non-uniformity distinguishes them from dendrimers, and they can therefore be prepared at considerably lower cost.

Among the dicarboxylic acids which can be reacted according to variant (m) are, by way of example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and cis- and trans-cyclopentane-1,3-dicarboxylic acid, and the abovementioned dicarboxylic acids may have substitution by one or more radicals selected from C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl, C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl; alkylene groups, such as methylene or ethylidene, or C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Examples which may be mentioned as representatives of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids which can be reacted according to variant (m) are also ethylenically unsaturated acids, such as maleic acid and fumaric acid, and aromatic dicarboxylic acids, such as phthalic acid, isophthalic acid or terephthalic acid.

It is also possible to use mixtures of two or more of the abovementioned representative compounds.

The dicarboxylic acids may either be used as they stand or be used in the form of derivatives.

Derivatives are preferably
the relevant anhydrides in monomeric or else polymeric form,
mono- or dialkyl esters, preferably mono- or dimethyl esters, or the corresponding mono- or diethyl esters, or else the mono- and dialkyl esters derived from higher alcohols, such as n-propanol, isopropanol, n-butanol, isobutanol, tert-butanol, n-pentanol, n-hexanol,
and also mono- and divinyl esters, and
mixed esters, preferably methyl ethyl esters.

However, it is also possible to use a mixture composed of a dicarboxylic acid and one or more of its derivatives. Equally, it is possible to use a mixture of two or more different derivatives of one or more dicarboxylic acids.

It is particularly preferable to use succinic acid, glutaric acid, adipic acid, phthalic acid, isophthalic acid, terephthalic acid, or the mono- or dimethyl esters thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (n) are benzene-1,2,4-tricarboxylic acid, benzene-1,3,5-tricarboxylic acid, benzene-1,2,4,5-tetracarboxylic acid, and mellitic acid.

Tricarboxylic acids or polycarboxylic acids may be used in the inventive reaction either as they stand or else in the form of derivatives.

Derivatives are preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else mono-, di-, or trivinyl esters
and mixed methyl ethyl esters.

It is also possible to use a mixture composed of a tri- or polycarboxylic acid and one or more of its derivatives. It is likewise possible to use a mixture of two or more different derivatives of one or more tri- or polycarboxylic acids, in order to obtain component B3).

Examples of diols used for variant (n) are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethylpentane-2,4-diol, 2-ethylhexane-1,3-diol, 2,5-dimethylhexane-2,5-diol, 2,2,4-trimethylpentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representative compounds of the above compounds, where n is a whole number and n=4. One, or else both, hydroxy groups here in the abovementioned diols may also be replaced by SH groups. Preference is given to ethylene glycol, propane-1,2-diol, and diethylene glycol, triethylene glycol, dipropylene glycol, and tripropylene glycol.

The molar ratio of the molecules A to molecules B in the AₓB_{y} polyester in the variants (m) and (n) is from 4:1 to 1:4, in particular from 2:1 to 1:2.

The at least trihydric alcohols reacted according to variant (m) of the process may have hydroxy groups of which all have identical reactivity. Preference is also given here to at least trihydric alcohols whose OH groups initially have identical reactivity, but where reaction with at least one acid group can induce a fall-off in reactivity of the remaining OH groups as a result of steric or electronic effects. By way of example, this applies when trimethylolpropane or pentaerythritol is used.

However, the at least trihydric alcohols reacted according to variant (m) may also have hydroxy groups having at least two different chemical reactivities.

The different reactivity of the functional groups here may derive either from chemical causes (e.g. primary/secondary/tertiary OH group) or from steric causes.

By way of example, the triol may comprise a triol which has primary and secondary hydroxy groups, a preferred example being glycerol.

When the inventive reaction is carried out according to variant (m), it is preferable to operate in the absence of diols and of monohydric alcohols.

When the inventive reaction is carried out according to variant (n), it is preferable to operate in the absence of mono- or dicarboxylic acids.

The process is carried out in the presence of a solvent. By way of example, hydrocarbons are suitable, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene, and ortho- and meta-dichlorobenzene. Other solvents very particularly suitable in the absence of acidic catalysts are: ethers, such as dioxane or tetrahydrofuran, and ketones, such as methyl ethyl ketone and methyl isobutyl ketone.

The amount of solvent added is at least 0.1% by weight, based on the weight of the starting materials used and to be reacted, preferably at least 1% by weight, and particularly preferably at least 10% by weight. It is also possible to use excesses of solvent, based on the weight of starting materials used and to be reacted, e.g. from 1.01 to 10 times the amount. Solvent amounts of more than 100 times the weight of the starting materials used and to be reacted are not advantageous, because the reaction rate decreases markedly at markedly lower concentrations of the reactants, giving uneconomically long reaction times.

To carry out the process, operations may be carried out in the presence of a dehydrating agent as additive, added at the start of the reaction. Suitable examples are molecular sieves, in particular 4 Å molecular sieve, MgSO₄, and Na₂SO₄. During the reaction it is also possible to add further dehydrating agent or to replace dehydrating agent by fresh dehydrating agent. During the reaction it is also possible to remove the water or alcohol formed by distillation and, for example, to use a water trap.

The process may be carried out in the absence of acidic catalysts. It is preferable to operate in the presence of an acidic inorganic, organometallic, or organic catalyst, or a mixture composed of two or more acidic inorganic, organometallic, or organic catalysts.

Examples of acidic inorganic catalysts are sulphuric acid, phosphoric acid, phosphonic acid, hypophosphorous acid, aluminium sulphate hydrate, alum, acidic silica gel (pH=6, in particular =5), and acidic aluminium oxide. Examples of other compounds which can be used as acidic inorganic catalysts are aluminium compounds of the general formula A1(OR)₃ and titanates of the general formula Ti(OR)₄, where each of the radicals R may be identical or different and is selected independently of the others from C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl, C₃-C₁₂-cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

Each of the radicals R in Al(OR)₃ or Ti(OR)₄ is preferably identical and selected from isopropyl or 2-ethylhexyl.

Examples of preferred acidic organometallic catalysts are selected from dialkyltin oxides R₂SnO, where R is defined as above. A particularly preferred representative compound for acidic organometallic catalysts is di-n-butyltin oxide, which is commercially available as “oxo-tin”, or di-n-butyltin dilaurate.

Preferred acidic organic catalysts are acidic organic compounds having, by way of example, phosphate groups, sulphonic acid groups, sulphate groups, or phosphonic acid groups. Particular preference is given to sulphonic acids, such as para-toluenesulphonic acid. Acidic ion exchangers may also be used as acidic organic catalysts, e.g. polystyrene resins comprising sulphonic acid groups and crosslinked with about 2 mol % of divinylbenzene.

It is also possible to use combinations of two or more of the abovementioned catalysts. It is also possible to use an immobilized form of those organic or organometallic, or else inorganic catalysts which take the form of discrete molecules.

If the intention is to use acidic inorganic, organometallic, or organic catalysts, according to the invention the amount used is from 0.1 to 10% by weight, preferably from 0.2 to 2% by weight, of catalyst.

The preparation process for component B3) is carried out under an inert gas, for example under carbon dioxide, nitrogen or a noble gas, among which particular mention may be made of argon. The inventive process is carried out at temperatures of from 60 to 200° C. It is preferable to operate at temperatures of from 130 to 180° C., in particular up to 150° C., or below that temperature. Maximum temperatures up to 145° C. are particularly preferred, and temperatures up to 135° C. are very particularly preferred. The pressure conditions for the inventive process are not critical. It is possible to operate at markedly reduced pressure, e.g. at from 10 to 500 mbar. The process may also be carried out at pressures above 500 mbar. The reaction at atmospheric pressure is preferred for reasons of simplicity; however, conduct at slightly increased pressure is also possible, e.g. up to 1200 mbar. It is also possible to operate at markedly increased pressure, e.g. at pressures up to 10 bar. Reaction at atmospheric pressure is preferred. The reaction time is usually from 10 minutes to 25 hours, preferably from 30 minutes to 10 hours, and particularly preferably from one to 8 hours.

Once the reaction has ended, the highly functional hyperbranched polyesters (B3) can easily be isolated, e.g. by removing the catalyst by filtration and concentrating the mixture, the concentration process here usually being carried out at reduced pressure. Other work-up methods with good suitability are precipitation after addition of water, followed by washing and drying.

Component B3) can also be prepared in the presence of enzymes or decomposition products of enzymes (according to DE-A 10 163 163). For the purposes of the present invention, the term acidic organic catalysts does not include the dicarboxylic acids reacted according to the invention.

It is preferable to use lipases or esterases. Lipases and esterases with good suitability are Candida cylindracea, Candida lipolytica, Candida rugosa, Candida antarctica, Candida utilis, Chromobacterium viscosum, Geotrichum viscosum, Geotrichum candidum, Mucor javanicus, Mucor mihei, pig pancreas, pseudomonas spp., pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, or esterase from Bacillus spp. and Bacillus thermoglucosidasius. Candida antarctica lipase B is particularly preferred. The enzymes listed are commercially available, for example from Novozymes Biotech Inc., Denmark.

The enzyme is preferably used in immobilized form, for example on silica gel or Lewatit®. The processes for immobilizing enzymes are known, e.g. from Kurt Faber, “Biotransformations in organic chemistry”, 3rd edition 1997, Springer Verlag, Chapter 3.2 “Immobilization” pp. 345-356. Immobilized enzymes are commercially available, for example from Novozymes Biotech Inc., Denmark.

The amount of immobilized enzyme to be used is from 0.1 to 20% by weight, in particular from 10 to 15% by weight, based on the total weight of the starting materials used and to be reacted.

The process using enzymes is carried out at temperatures above 60° C. It is preferable to operate at temperatures of 100° C. or below that temperature. Preference is given to temperatures up to 80° C., very particular preference is given to temperatures of from 62 to 75° C., and still more preference is given to temperatures of from 65 to 75° C.

The process using enzymes is carried out in the presence of a solvent. Examples of suitable compounds are hydrocarbons, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene and ortho- and meta-dichlorobenzene. Other very particularly suitable solvents are: ethers, such as dioxane or tetrahydrofuran, and ketones, such as methyl ethyl ketone and methyl isobutyl ketone.

The amount of solvent added is at least 5 parts by weight, based on the weight of the starting materials used and to be reacted, preferably at least 50 parts by weight, and particularly preferably at least 100 parts by weight. Amounts of more than 10 000 parts by weight of solvent are undesirable, because the reaction rate decreases markedly at markedly lower concentrations, giving uneconomically long reaction times.

The process using enzymes is carried out at pressures above 500 mbar. Preference is given to the reaction at atmospheric pressure or slightly increased pressure, for example at up to 1200 mbar. It is also possible to operate under markedly increased pressure, for example at pressures up to 10 bar. The reaction at atmospheric pressure is preferred.

The reaction time for the process using enzymes is usually from 4 hours to 6 days, preferably from 5 hours to 5 days, and particularly preferably from 8 hours to 4 days.

Once the reaction has ended, the highly functional hyperbranched polyesters can be isolated, e.g. by removing the enzyme by filtration and concentrating the mixture, this concentration process usually being carried out at reduced pressure. Other work-up methods with good suitability are precipitation after addition of water, followed by washing and drying.

The highly functional, hyperbranched polyesters B3) obtainable by this process feature particularly low contents of discoloured and resinified material. For the definition of hyperbranched polymers, see also: P. J. Flory, J. Am. Chem. Soc. 1952, 74, 2718, and A. Sunder et al., Chem. Eur. J. 2000, 6, no. 1, 1-8. However, in the context of the present invention, “highly functional hyperbranched” means that the degree of branching, i.e. the average number of dendritic linkages plus the average number of end groups per molecule, is from 10 to 99.9%, preferably from 20 to 99%, particularly preferably from 30 to 90% (see in this connection H. Frey et al. Acta Polym. 1997, 48, 30).

The molar mass M_{w} of the polyesters B3) is from 500 to 50 000 g/mol, preferably from 1000 to 20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They are usually very soluble, i.e. clear solutions can be prepared using up to 50% by weight, in some cases even up to 80% by weight, of the polyesters B3) in tetrahydrofuran (THF), n-butyl acetate, ethanol, and numerous other solvents, with no gel particles detectable by the naked eye.

The highly functional hyperbranched polyesters B3) are carboxy-terminated, carboxy- and hydroxy-terminated, but preferably only hydroxy-terminated.

If mixtures of the B) components are used, the ratios of components B1) to B2) or B2) to B3) or

B1) to B3) are preferably from 1:20 to 20:1, in particular from 1:15 to 15:1 and very particularly from 1:5 to 5:1. If a mixture composed of B1), B2) and B3) is used, the mixing ratio is preferably from 1:1:20 to 1:20:1 or to 20:1:1.

The hyperbranched polycarbonates B2)/polyesters B3) used are particles whose size is from 20 to 500 nm. In the polymer blend these nanoparticles take the form of fine particles, and the size of the particles in the compounded material is from 20 to 500 nm, preferably from 50 to 300 nm.

Compounded materials of this type are available commercially, e.g. in the form of Ultradur® high speed.
In one preferred embodiment, the present invention provides lightweight components composed of a shell-type parent body whose external or internal space has reinforcing structures securely connected to the parent body and composed of moulded-on thermoplastics, and having connection to the parent body at discrete connection sites, characterized in that polymer moulding compositions are used comprising
   A) from 99.99 to 10 parts by weight, preferably from 99.5 to 40 parts by weight, particularly preferably from 99.0 to 55 parts by weight of at least one semicrystalline thermoplastic polymer, preferably polyamide or polyester, particularly preferably polyamide and
   B1) from 0.01 to 50 parts by weight, preferably from 0.25 to 20 parts by weight, particularly preferably from 1.0 to 15 parts by weight, of at least one copolymer composed of at least one olefin, preferably one α-olefin, with at least one methacrylate or acrylate of an aliphatic alcohol, preferably of an aliphatic alcohol having from 1 to 30 carbon atoms, where the MFI of the copolymer B1) is not less than 100 g/10 min, preferably not less than 150 g/10 min.

In another preferred embodiment of the present invention, moulding compositions used for the lightweight components of hybrid design also comprise, in addition to component A) and B),
C) from 0.001 to 75 parts by weight, preferably from 10 to 70 parts by weight, particularly preferably from 20 to 65 parts by weight, with particular preference from 30 to 65 parts by weight, of a filler or reinforcing material.

The filler or reinforcing material used can also comprise a mixture composed of two or more different fillers and/or reinforcing materials, for example based on talc, or mica, silicate, quartz, titanium dioxide, wollastonite, kaolin, amorphous silicas, magnesium carbonate, chalk, feldspat, barium sulphate, glass beads and/or fibrous fillers and/or reinforcing materials based on carbon fibres and/or glass fibres. It is preferable to use mineral particulate fillers based on talc, mica, silicate, quartz, titanium dioxide, wollastonite, kaolin, amorphous silicas, magnesium carbonate, chalk, feldspat, barium sulphate and/or glass fibres. It is particularly preferable to use mineral particulate fillers based on talc, wollastonite, kaolin and/or glass fibres, very particular preference being given to glass fibres.

Particularly for applications in which isotropy in dimensional stability and high thermal dimensional stability is demanded, as for example in motor vehicle applications for external bodywork parts, it is preferable to use mineral fillers, in particular talc, wollastonite or kaolin.

Particular preference is moreover also given to the use of acicular mineral fillers. According to the invention, the term acicular mineral fillers means a mineral filler having pronounced acicular character. An example that may be mentioned is acicular wollastonites. The length:diameter ratio of the mineral is preferably from 2:1 to 35:1, particularly preferably from 3:1 to 19:1, with particular preference from 4:1 to 12:1. The average particle size, determined using a CILAS GRANULOMETER, of the inventive acicular minerals is preferably smaller than 20 μm, particularly preferably smaller than 15 μm, with particular preference smaller than 10 μm.

The filler and/or reinforcing material can, if appropriate, have been surface-modified, for example with a coupling agent or coupling-agent system, for example based on silane. However, this pre-treatment is not essential. However, in particular when glass fibres are used it is also possible to use polymer dispersions, film-formers, branching agents and/or glass-fibre-processing aids, in addition to silanes.

The glass fibres whose use is particularly preferred according to the invention are added in the form of continuous-filament fibres or in the form of chopped or ground glass fibres, their fibre diameter generally being from 7 to 18 μm, preferably from 9 to 15 μm. The fibres can have been provided with a suitable size system and with a coupling agent or coupling-agent system, for example based on silane.

Coupling agents based on silane and commonly used for the pre-treatment are silane compounds, preferably silane compounds of the general formula (VIII)

(X—(CH₂)_{q})ₖ—Si—(O—CᵣH₂ᵣ₊₁)₄₋ₖ (VIII)

in which

### X is NH₂—, HO— or

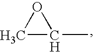

q is a whole number from 2 to 10, preferably from 3 to 4,

r is a whole number from 1 to 5, preferably from 1 to 2 and

k is a whole number from 1 to 3, preferably 1.

Coupling agents to which further preference is given are silane compounds from the group of aminopropyltrimethoxysilane, aminobutyltrimethoxysilane, aminopropyltriethoxysilane, aminobutyltriethoxysilane, and also the corresponding silanes which have a glycidyl group as substituent X.

The amounts generally used of the silane compounds for surface coating for modification of the fillers is from 0.05 to 2% by weight, preferably from 0.25 to 1.5% by weight and in particular from 0.5 to 1% by weight, based on the mineral filler.

As a result of the processing to give the moulding composition or moulding, the d97 value or d50 value of the particulate fillers can be smaller in the moulding composition or in the moulding than in the fillers originally used. As a result of the processing to give the moulding composition or moulding, the length distributions of the glass fibres in the moulding composition or the moulding can be shorter than those originally used.

In an alternative preferred embodiment, the polymer moulding compositions to be used for the production of the inventive hybrid-based lightweight components can also comprise, if appropriate, in addition to components A) and B) and C), or instead of C),
D) from 0.001 to 30 parts by weight, preferably from 5 to 25 parts by weight, particularly preferably from 9 to 19 parts by weight, of at least one flame-retardant additive.

The flame-retardant additive or flame retardant D) used can comprise commercially available organic halogen compounds with synergists or can comprise commercially available organic nitrogen compounds or organic/inorganic phosphorus compounds, individually or in a mixture. It is also possible to use flame-retardant additives such as magnesium hydroxide or Ca Mg carbonate hydrates (e.g. DE-A 4 236 122 (=CA 210 9024 A1)). It is also possible to use salts of aliphatic or aromatic sulphonic acids. Examples that may be mentioned of halogen-containing, in particular brominated and chlorinated, compounds are: ethylene-1,2-bistetrabromophthalimide, epoxidized tetrabromobisphenol A resin, tetrabromobisphenol A oligocarbonate, tetrachlorobisphenol A oligocarbonate, pentabromopolyacrylate, brominated polystyrene and decabromodiphenyl ether. Examples of suitable organic phosphorus compounds are the phosphorus compounds according to WO-A 98/17720 (=U.S. Pat. No. 6,538,024), e.g. triphenyl phosphate (TPP), resorcinol bis(diphenyl phosphate) (RDP) and the oligomers derived therefrom, and also bisphenol A bis(diphenyl phosphate) (BDP) and the oligomers derived therefrom, and moreover organic and inorganic phosphonic acid derivatives and their salts, organic and inorganic phosphinic acid derivatives and their salts, in particular metal dialkylphosphinates, such as aluminium tris[dialkylphosphinates] or zinc bis[dialkylphosphinates], and moreover red phosphorus, phosphites, hypophosphites, phosphine oxides, phosphazenes, melamine pyrophosphate and mixtures of these. Nitrogen compounds that can be used are those from the group of the allantoin derivatives, cyanuric acid derivatives, dicyandiamide derivatives, glycoluril derivatives, guanidine derivatives, ammonium derivatives and melamine derivatives, preferably allantoin, benzoguanamine, glycoluril, melamine, condensates of melamine, e.g. melem, melam or melom, or compounds of this type having higher condensation level and adducts of melamine with acids, e.g. with cyanuric acid (melamine cyanurate), with phosphoric acid (melamine phosphate) or with condensed phosphoric acids (e.g. melamine polyphosphate). Examples of suitable synergists are antimony compounds, in particular antimony trioxide, sodium antimonate and antimony pentoxide, zinc compounds, e.g. zinc borate, zinc oxide, zinc phosphate and zinc sulphide, tin compounds, e.g. tin stannate and tin borate, and also magnesium compounds, e.g. magnesium oxide, magnesium carbonate and magnesium borate. Materials known as carbonizers can also be added to the flame retardant, examples being phenolformalde resins, polycarbonates, polyphenyl ethers, polyimides, polysulphones, polyether sulphones, polyphenylene sulphides, and polyether ketones, and also antidrip agents, such as tetrafluoroethylene polymers.

In another alternative preferred embodiment, the polymer moulding compositions to be used for the production of the inventive hybrid-based lightweight components can also comprise, if appropriate, in addition to components A) and B) and C) and/or D) or instead of C) and/or D),
E) from 0.001 to 80 parts by weight, particularly preferably from 2 to 19 parts by weight, with particular preference from 9 to 15 parts by weight, of at least one elastomer modifier.

The elastomer modifiers to be used as component E) comprise one or more graft polymers of
E.1 from 5 to 95% by weight, preferably from 30 to 90% by weight, of at least one vinyl monomer on
E.2 from 95 to 5% by weight, preferably from 70 to 10% by weight, of one or more graft bases whose glass transition temperatures are <10° C., preferably <0° C., particularly preferably <−20° C.

The average particle size (d₅₀ value) of the graft base E.2 is generally from 0.05 to 10 μm, preferably from 0.1 to 5 μm, particularly preferably from 0.2 to 1 μm.

Monomers E.1 are preferably mixtures composed of
E.1.1 from 50 to 99% by weight of vinylaromatics and/or ring-substituted vinylaromatics (such as styrene, α-methylstyrene, p-methylstyrene, p-chlorostyrene) and/or (C₁-C₈)-alkyl methacrylates (e.g. methyl methacrylate, ethyl methacrylate) and
E.1.2 from 1 to 50% by weight of vinyl cyanides (unsaturated nitriles, such as acrylonitrile and methacrylonitrile) and/or (C₁-C₈)-alkyl (meth)acrylates (e.g. methyl methacrylate, n-butyl acrylate, tert-butyl acrylate) and/or derivatives (such as anhydrides and imides) of unsaturated carboxylic acids (e.g. maleic anhydride and N-phenylmaleimide).

Preferred monomers E.1.1 have been selected from at least one of the monomers styrene, α-methylstyrene and methyl methacrylate, and preferred monomers E.1.2 have been selected from at least one of the monomers acrylonitrile, maleic anhydride and methyl methacrylate.

Particularly preferred monomers are E.1.1 styrene and E.1.2 acrylonitrile.

Examples of suitable graft bases E.2 for the graft polymers to be used in the elastomer modifiers E) are diene rubbers, EP(D)M rubbers, i.e. rubbers based on ethylene/propylene and, if appropriate, diene, acrylate rubbers, polyurethane rubbers, silicone rubbers, chloroprene rubbers and ethylene-vinyl acetate rubbers.

Preferred graft bases E.2 are diene rubbers (e.g. based on butadiene, isoprene, etc.) or mixtures of diene rubbers, or are copolymers of diene rubbers or of their mixtures with further copolymerizable monomers (e.g. according to E.1.1 and E.1.2), with the proviso that the glass transition temperature of component E.2 is <10° C., preferably <0° C., particularly preferably <−10° C.

Examples of particularly preferred graft bases E.2 are ABS polymers (emulsion, bulk and suspension ABS), as described by way of example in DE-A 2 035 390 (=US-A 3 644 574) or in DE-A 2 248 242 (=GB-A 1 409 275) or in Ullmann, Enzyklopädie der Technischen Chemie [Encyclopaedia of Industrial Chemistry], Vol. 19 (1980), pp. 280 et seq. The gel content of the graft base E.2 is preferably at least 30% by weight, particularly preferably at least 40% by weight (measured in toluene).

The elastomer modifiers or graft polymers E) are prepared via free-radical polymerization, e.g. via emulsion, suspension, solution or bulk polymerization, preferably via emulsion or bulk polymerization.

Other particularly suitable graft rubbers are ABS polymers which are prepared via redox initiation using an initiator system composed of organic hydroperoxide and ascorbic acid according to US-A 4 937 285.

Because it is known that the graft monomers are not necessarily entirely grafted onto the graft base during the grafting reaction, products which are obtained via (co)polymerization of the graft monomers in the presence of the graft base and are produced concomitantly during the work-up are also graft polymers E) according to the invention.

Suitable acrylate rubbers are based on graft bases E.2 which are preferably polymers composed of alkyl acrylates, if appropriate with up to 40% by weight, based on E.2, of other polymerizable, ethylenically unsaturated monomers. Among the preferred polymerizable acrylic esters are C₁-C₈-alkyl esters, such as methyl, ethyl, butyl, n-octyl and 2-ethylhexyl esters; haloalkyl esters, preferably halo-C₁-C₈-alkyl esters, such as chloroethyl acrylate, and also mixtures of these monomers.

For crosslinking, monomers having more than one polymerizable double bond can be copolymerized. Preferred examples of crosslinking monomers are esters of unsaturated monocarboxylic acids having from 3 to 8 carbon atoms and esters of unsaturated monohydric alcohols having from 3 to 12 carbon atoms, or of saturated polyols having from 2 to 40H groups and from 2 to 20 carbon atoms, e.g. ethylene glycol dimethacrylate, allyl methacrylate; polyunsaturated heterocyclic compounds, e.g. trivinyl and triallyl cyanurate; polyfunctional vinyl compounds, such as di- and trivinylbenzenes; and also triallyl phosphate and diallyl phthalate.

Preferred crosslinking monomers are allyl methacrylate, ethylene glycol dimethacrylate, diallyl phthalate and heterocyclic compounds which have at least 3 ethylenically unsaturated groups.

Particularly preferred crosslinking monomers are the cyclic monomers triallyl cyanurate, triallyl isocyanurate, triacryloylhexahydro-s-triazine, and triallylbenzenes. The amount of the crosslinking monomers is preferably from 0.02 to 5% by weight, in particular from 0.05 to 2% by weight, based on the graft base E.2.

In the case of cyclic crosslinking monomers having at least 3 ethylenically unsaturated groups, it is advantageous to restrict the amount to below 1% by weight of the graft base E.2.

Examples of preferred “other” polymerizable, ethylenically unsaturated monomers which can serve alongside the acrylic esters, if appropriate, for preparation of the graft base E.2 are acrylonitrile, styrene, α-methylstyrene, acrylamides, vinyl C₁-C₆-alkyl ethers, methyl methacrylate, butadiene. Acrylate rubbers preferred as graft base E.2 are emulsion polymers whose gel content is at least 60% by weight.

Further suitable graft bases according to E.2 are silicone rubbers having sites active for grafting purposes, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Alongside elastomer modifiers based on graft polymers, it is also possible to use, as component E), elastomer modifiers not based on graft polymers but having glass transition temperatures<10° C., preferably <0° C., particularly preferably <−20° C. Among these can be, by way of example, elastomers with block copolymer structure. Among these can also be, by way of example, elastomers which can undergo thermoplastic melting. Preferred materials mentioned here by way of example are EPM rubbers, EPDM rubbers and/or SEBS rubbers.

In another alternative preferred embodiment, the polymer moulding compositions to be used for the production of the inventive hybrid-based lightweight components also comprise, if appropriate, in addition to components A) and B) and C) and/or D) and/or E) or instead of C), D) or E),
F) from 0.001 to 10 parts by weight, preferably from 0.05 to 3 parts by weight, particularly preferably from 0.1 to 0.9 part by weight, of further conventional additives.

For the purposes of the present invention, examples of conventional additives are stabilizers (e.g. UV stabilizers, heat stabilizers, gamma-ray stabilizers), antistatic agents, flow aids, mould-release agents, further fire-protection additives, emulsifiers, nucleating agents, plasticizers, lubricants, dyes, pigments and additives for increasing electrical conductivity. The additives mentioned and further suitable additives are described by way of example in Gächter, Müller, Kunststoff-Additive [Plastics Additives], 3rd Edition, Hanser-Verlag, Munich, Vienna, 1989 and in Plastics Additives Handbook, 5th Edition, Hanser-Verlag, Munich, 2001. The additives may be used alone or in a mixture, or in the form of masterbatches.

Preferred stabilizers used are sterically hindered phenols, hydroquinones, aromatic secondary amines, e.g. diphenylamines, substituted resorcinols, salicylates, benzotriazoles and benzophenones, and also various substituted representatives of these groups and mixtures thereof.

Preferred pigments and dyes used are titanium dioxide, zinc sulphide, ultramarine blue, iron oxide, carbon black, phthalocyanines, quinacridones, perylenes, nigrosin and anthraquinones.

Preferred nucleating agents used are sodium phenylphosphinate or calcium phenylphosphinate, aluminium oxide, silicon dioxide, and also particularly preferably talc.

Preferred lubricants and mould-release agents used are ester waxes, pentaerythritol tetrastearate (PETS), long-chain fatty acids (e.g. stearic acid or behenic acid) and fatty acid esters, salts thereof (e.g. Ca stearate or Zn stearate), and also amide derivatives (e.g. ethylenebisstearylamide) or montan waxes (mixtures composed of straight-chain, saturated carboxylic acids having chain lengths of from 28 to 32 carbon atoms), and also low-molecular-weight polyethylene waxes and polypropylene waxes.

Preferred plasticizers used are dioctyl phthalate, dibenzyl phthalate, butyl benzyl phthalate, hydrocarbon oils, N-(n-butyl)benzenesulphonamide.

Preferred additives which can be added to increase electrical conductivity are carbon blacks, conductivity blacks, carbon fibrils, nanoscale graphite fibres and carbon fibres, graphite, conductive polymers, metal fibres, and also other conventional additives for increasing electrical conductivity. Nanoscale fibres which can preferably be used are those known as “single-wall carbon nanotubes” or “multiwall carbon nanotubes” (e.g. from Hyperion Catalysis).

In another alternative preferred embodiment, the polyamide moulding compositions can also comprise, if appropriate, in addition to components A) and B) and C), and/or D), and/or E), and/or F), or instead of C), D), E) or F),
G) from 0.5 to 30 parts by weight, preferably from 1 to 20 parts by weight, particularly preferably from 2 to 10 parts by weight and most preferably from 3 to 7 parts by weight, of compatibilizer.

Compatibilizers used preferably comprise thermoplastic polymers having polar groups.

According to the invention, polymers used are therefore those which contain
G.1 a vinylaromatic monomer,
G.2 at least one monomer selected from the group of C₂-C₁₂-alkyl methacrylates, C₂-C₁₂-alkyl acrylates, methacrylonitriles and acrylonitriles and
G.3 dicarboxylic anhydrides containing α,β-unsaturated components.

The component G used preferably comprises terpolymers of the monomers mentioned. Accordingly, it is preferable to use terpolymers of styrene, acrylonitrile and maleic anhydride. In particular, these terpolymers contribute to improvement in mechanical properties, such as tensile strength and tensile strain at break. The amount of maleic anhydride in the terpolymer can vary widely. The amount is preferably from 0.2 to 5 mol %. Amounts of from 0.5 to 1.5 mol % are particularly preferred. In this range, particularly good mechanical properties are achieved in relation to tensile strength and tensile strain at break.

The terpolymer can be prepared in a known manner. One suitable method is to dissolve monomer components of the terpolymer, e.g. styrene, maleic anhydride or acrylonitrile, in a suitable solvent, e.g. methyl ethyl ketone (MEK). One or, if appropriate, more chemical initiators are added to this solution. Examples of suitable initiators are peroxides. The mixture is then polymerized at elevated temperatures for a number of hours. The solvent and the unreacted monomers are then removed in a manner known per se.

The ratio of component G.1 (vinylaromatic monomer) to component G.2, e.g. the acrylonitrile monomer in the terpolymer is preferably from 80:20 to 50:50.

Styrene is particularly preferred as vinylaromatic monomer G. 1. Acrylonitrile is particularly preferably suitable for component G.2. Maleic anhydride is particularly preferably suitable as component G.3.

EP-A 0 785 234 (=U.S. Pat. No. 5,756,576) and EP-A 0 202 214 (=U.S. Pat. No. 4,713,415) describe examples of compatibilizers G) which can be used according to the invention. According to the invention, particular preference is given to the polymers mentioned in EP-A 0 785 234.

The compatibilizers can be present in component G) alone or in any desired mixture with one another.

Another substance particularly preferred as compatibilizer is a terpolymer of styrene and acyrlonitrile in a ratio of 2.1:1 by weight containing 1 mol % of maleic anhydride.

Component G) is used particularly when the moulding composition comprises graft polymers, as described under E).

According to the invention, the following combinations of the components are preferred in polymer moulding compositions for use in hybrid-based lightweight components:

A,B; A,B,C; A,B,D; A,B,E; A,B,F; A,B,G; A,B,C,D; A,B,C,E; A,B,C,F; A,B,C,G; A,B,D,E; A,B,D,F; A,B,D,G; A,B,E,F; A,B,E,G; A,B,F,G; A,B,C,D,E; A,B,C,D,G; A,B,C,F,G; A,B,E,F,G; A,B,D,F,G; A,B,C,D,E,F; A,B,C,D,E,G; A,B,D,E,F,G; A,B,C,E,F,G; A,B,C,D,E,G; A,B,C,D,E,F,G.

The hybrid-based lightweight components to be produced according to the invention from the polymer moulding compositions used feature impact resistance higher than that of mouldings composed of moulding compositions of comparable melt viscosity, prepared via use of a relatively low-viscosity polymer as component A). By virtue of the unusually high modulus of elasticity of about 19 000 MPa at room temperature when polyamide is used as component A) in combination for example with a component B1) the content of glass fibres can be doubled from 30% by weight to 60% by weight, leading to doubled rigidity of a hybrid-based lightweight component produced therefrom. Surprisingly, the increase in density of the polymer moulding composition here is merely about 15-20%. This permits marked reduction in the wall thicknesses of the components for the same mechanical performance with markedly reduced manufacturing costs. Motor vehicle front ends, a standard application of hybrid technology, can thus be designed to be lighter and or more rigid, and this is attended by a reduction of 30-40% in weight and in manufacturing costs.

At the same time, a higher level of force means that the front end of hybrid design can absorb more energy in the event of a crash.

The following are therefore possible application sectors for hybrid-based lightweight components to be produced according to the invention with flow improver B) from a shell-type parent body whose external or internal space has reinforcing structures, preferably in rib form, securely connected to the parent body and composed of moulded-on thermoplastics, and having connection to the parent body at discrete connection sites by way of perforations in the parent body:

vehicle parts of (automotive sector) in load-bearing parts of office machinery, household machines or other machinery, in design elements for decorative purposes, in staircases, in escalator steps, or in manhole covers.

They are preferably used in motor vehicles as complete front ends, pedestrian-protection beam, specific-purpose slam panels for engine hoods or luggage-compartment lids, front roof arches, rear roof arches, roof frames, roof modules (entire roof), sliding-roof support parts, dashboard support parts (cross car beam), steering column retainers, fire wall, pedals, pedal blocks, gear-shift blocks, A, B or C columns, B-column modules, longitudinal members, jointing elements for the connection of longitudinal members and B columns, and of jointing elements for the connection of A column to transverse member, jointing elements for the connection of A column, transverse member and longitudinal member, transverse members, wheel surrounds, wheel-surround modules, crash boxes, rear ends, spare-wheel recesses, engine hoods, engine covers, water-tank assembly, engine-rigidity systems (front-end rigidity system), vehicle floor, floor-rigidity systems, seat-rigidity systems, transverse seat members, tail-gates, vehicle frames, seat structures, back-rests, seat shells, seat back-rests with and without safety-belt integration, parcel shelves, valve covers, end-shields for generators or electric motors, complete vehicle-door structures, side-impact members, module members, oil sumps, gearbox oil sumps, oil modules, headlamp frames, door seal, door-seal reinforcement, chassis components, and also motor-scooter frames.

Preferred use of the inventive lightweight components of hybrid design in the non-automotive sector is in electrical or electronic equipment, in household equipment, in furniture, in heaters, in shopping trolleys, in shelving, in staircases, in escalator steps, or in manhole covers.

However, the inventive hybrid-based lightweight components are, of course, also suitable for use in rail vehicles, in aircraft, in ships, in sleds, in motor scooters or in other means of conveyance, where importance is placed on designs which are lightweight but stable.

However, the present invention also provides a process for the production of a lightweight component of hybrid design whose external and/or internal space has reinforcing structures securely connected to the parent body and composed of moulded-on thermoplastics, and having connection to the parent body at discrete connection sites by way of perforations in the parent body, characterized in that polymer moulding compositions comprising
A) from 99.99 to 10 parts by weight, preferably from 99.5 to 40 parts by weight, particularly preferably from 99.0 to 55 parts by weight, of at least one semicrystalline thermoplastic polymer and
B) from 0.01 to 50 parts by weight, preferably from 0.25 to 20 parts by weight, particularly preferably from 1.0 to 15 parts by weight
B1) of at least one copolymer composed of at least one olefin, preferably one α-olefin, with at least one methacrylate or acrylate of an aliphatic alcohol, preferably of an aliphatic alcohol having from 3 to 50 carbon atoms, where the MFI of the copolymer B1) is not less than 100 g/10 min, preferably not less than 150 g/10 min, or
B2) of at least one highly branched or hyperbranched polycarbonate with an OH number of from 1 to 600 mg KOH/g of polycarbonate (to DIN 53240, Part 2), or
B3) of at least one highly branched or hyperbranched polyester of AₓB_{y} type, where x is at least 1.1 and y is at least 2.1, or
   a mixture of B1) with B2) or of B1) with B3) or of B2) with B3) or of B1) with B2) and with B3), in each case with A) are processed via shaping processes, preferably via injection moulding, melt extrusion, compression moulding, stamping or blow moulding, in a shaping mould.

However, the present invention also provides a method for reduction of the weight of components, preferably of vehicles of any type, characterized in that lightweight components are used and are composed of a shell-type parent body and their external and/or internal space has reinforcing structures securely connected to the parent body and composed of moulded-on thermoplastics, and having connection to the parent body at discrete connection sites, where the thermoplastics are produced from polymer moulding compositions comprising
A) from 99.99 to 10 parts by weight, preferably from 99.5 to 40 parts by weight, particularly preferably from 99.0 to 55 parts by weight, of at least one semicrystalline thermoplastic polymer and
B) from 0.01 to 50 parts by weight, preferably from 0.25 to 20 parts by weight, particularly preferably from 1.0 to 15 parts by weight
B1) of at least one copolymer composed of at least one olefin, preferably one α-olefin, with at least one methacrylate or acrylate of an aliphatic alcohol, preferably of an aliphatic alcohol having from 3 to 50 carbon atoms, where the MFI of the copolymer B1) is not less than 100 g/10 min, preferably not less than 150 g/10 min, or
B2) of at least one highly branched or hyperbranched polycarbonate with an OH number of from 1 to 600 mg KOH/g of polycarbonate (to DIN 53240, Part 2), or
B3) of at least one highly branched or hyperbranched polyester of AₓB_{y} type, where x is at least 1.1 and y is at least 2.1, or
   a mixture of B1) with B2) or of B1) with B3) or of B2) with B3) or of B1) with B2) and with B3), in each case with A).

For the purposes of the present invention, “securely connected” means that the extruded polymer is by way of example pressed through openings in the parent body and flows out on the opposite side of the opening over its edges, to give a secure interlock bond on solidification. In one preferred embodiment, as described above, the connection of the moulded-on thermoplastic to the parent body takes place at discrete connection sites by way of perforations in the parent body, through which the plastic (thermoplastic) extends and extends across the area of the perforations, and a particularly secure interlock bond is thus achieved. However, this can also take place in an additional operation, in that flash material protruding by way of openings is again subjected to mechanical working with a tool in such a way as to produce a secure interlock bond. The term “securely connected” also includes subsequent incorporation by adhesion using adhesives or using a laser. However, the secure interlock bond can also be achieved via flow around (forming a web around) the parent body.

However, the present invention also provides vehicles or other means of conveyance, particularly motor vehicles, rail vehicles, aircraft, ships, sleds or motor scooters, comprising a lightweight component of hybrid design whose external and/or internal space has reinforcing structures securely connected to the parent body and composed of moulded-on thermoplastics, and having connection to the parent body at discrete connection sites, characterized in that polymer moulding compositions are used comprising
A) from 99.99 to 10 parts by weight, preferably from 99.5 to 40 parts by weight, particularly preferably from 99.0 to 55 parts by weight, of at least one semicrystalline thermoplastic polymer and
B) from 0.01 to 50 parts by weight, preferably from 0.25 to 20 parts by weight, particularly preferably from 1.0 to 15 parts by weight
B1) of at least one copolymer composed of at least one olefin, preferably one α-olefin, with at least one methacrylate or acrylate of an aliphatic alcohol, preferably of an aliphatic alcohol having from 3 to 50 carbon atoms, where the MFI of the copolymer B1) is not less than 100 g/10 min, preferably not less than 150 g/10 min, or
B2) of at least one highly branched or hyperbranched polycarbonate with an OH number of from 1 to 600 mg KOH/g of polycarbonate (to DIN 53240, Part 2), or
B3) of at least one highly branched or hyperbranched polyester of AₓB_{y} type, where x is at least 1.1 and y is at least 2.1, or
   a mixture of B1) with B2) or of B1) with B3) or of B2) with B3) or of B1) with B2) and with B3), in each case with A), and installs these within the vehicle.

### EXAMPLES

The technical superiority of the inventive hybrid-based lightweight components is demonstrated by using various products based on polyamide (=component A) from Lanxess Deutschland GmbH:

Durethan® BKV 30 is a moulding composition based on polyamide without the constituents B1), B2) or B3) to be used according to the invention.

Durethan® BKV 30×F is a moulding composition based on polyamide and on component B1).

### Example 1

### Flow Path Length/Wall Thickness (Flow Path Length in mm) Relationship for the Production of an Inventive Hybrid Component at a Melt Temperature of 280° C., a Mould Temperature of 80° C. and an Injection Pressure of 650 Bar

| Wall thickness [mm] | 1 | 2 | 3 | 4 |
|---|---|---|---|---|
| BKV 30 | 90 | 230 | 485 | 760 |
| BKV 30XF | 150 | 405 | 790 | 1250 |

The table shows that Durethan® BKV 30×F has markedly improved flow when compared with a conventional product. The figures give the flow path length in the mould in mm. Durethan® BKV 30 XF therefore has excellent suitability for the production of hybrid components.

### Example 2

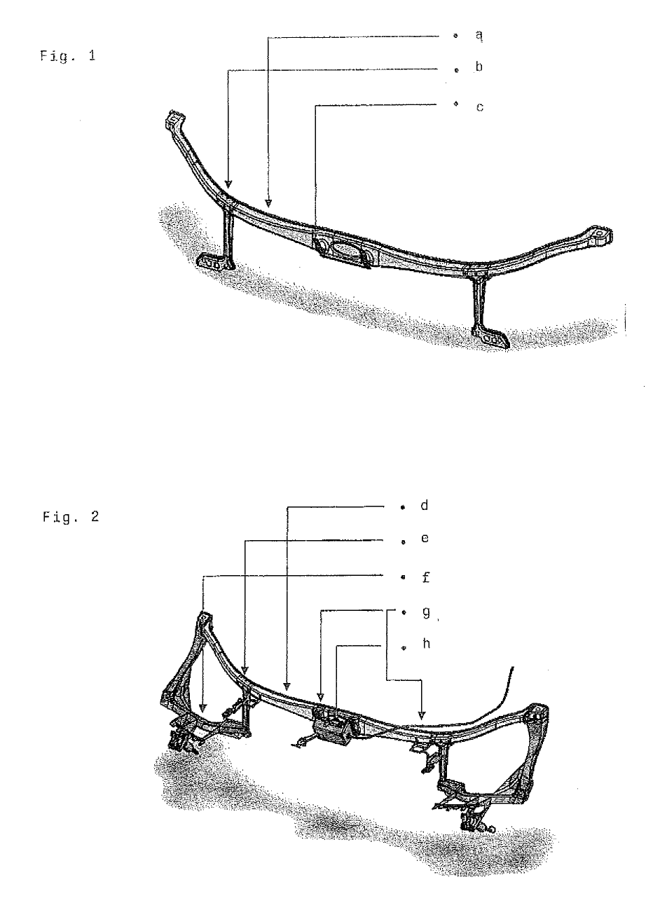

### Weight Saving in Grams on a Motor Vehicle Front End Member of Hybrid Design According to FIG. 1 with No Loss of Stability Properties

In FIG. 1 and also in the table,

a=hybrid upper web

b=hybrid vertical strut

c=weld nut member

| | | Steel sheet in hybrid component |
|---|---|---|
| | | produced according to the |
| | Steel sheet in hybrid | invention from an improved- |
| | component according | flow polyamide moulding |
| | to prior art | composition |
| a | 850 | 763 |
| b | 260 | 190 |
| c | 400 | 200 |
| Total weight | 1510 | 1153 |
| Steel sheet | | |

Saving on vehicle front end member via use of an improved-flow polyamide moulding composition based on Lotryl ®EH as B1): 357 g

### Example 3

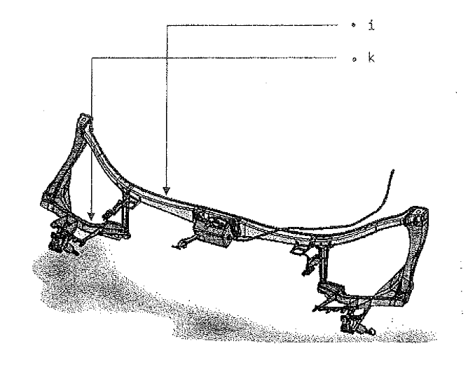

### Weight Saving in Grams on a Vehicle Front End Member of Hybrid Design According to FIG. 2

In FIG. 2, and also in the table,

d=hybrid upper web, ribs and overmoulding

e=hybrid vertical strut, ribs and overmoulding

f=headlamp frame

g=receptacles

h=theft-prevention system

| | Plastics content in | Plastics content |
|---|---|---|
| | hybrid component | in hybrid |
| | according to | component according |
| | prior art | to the invention |
| d | 840 | 440 |
| e | 270 | 46 |
| f | 1240 | 667 |
| g | 530 | 400 |
| h | — | 70 |
| Total weight of | 2880 | 1553 |
| plastic | | |

Saving: 1327 g weight

The table shows that the low weight of a front end produced using inventive flow improvers leads to marked reductions in weight and therefore permits additional applications, such as theft prevention, without comprising the stability of the component and therefore the safety of the motor vehicle. Lower weight of components therefore permits savings in fuel during operation of the motor vehicle and economic use of resources.

### Example 4

### Weight Saving in Grams on a Motor Vehicle Front End Member of Hybrid Design According to FIG. 3 with No Loss of Stability Properties

In FIG. 3, and also in the table,

i=steel sheet

k=plastics structure

| | Hybrid component | Hybrid component according |
|---|---|---|
| | according to prior art | to the invention |
| i | 1510 | 1153 |
| k | 2880 | 1553 |
| Total weight | 4390 | 2706 |

Saving: 1684 g weight

Again, this table demonstrates impressively the saving in weight for an inventive polyamide-based hybrid front end member produced using Lotryl®EH, in comparison with a corresponding front end member produced from moulding compositions with no flow aid according to component B.

1. Lightweight components composed of a shell-type parent body whose external and/or internal space has reinforcing structures securely connected to the parent body and composed of molded-on thermoplastics, and having connection to the parent body at discrete connection sites, said lightweight components further comprising polymer molding compositions comprising:
A) from 99.99 to 10 parts by weight of at least one semicrystalline thermoplastic polymer and
B) from 0.01 to 50 parts by weight
B1) of at least one copolymer composed of at least one olefin with at least one methacrylate or acrylate of an aliphatic alcohol where the MFI of the copolymer B1) is not less than 100 g/10 min, or
B2) of at least one highly branched or hyperbranched polycarbonate with an OH number of from 1 to 600 mg KOH/g of polycarbonate (to DIN 53240, Part 2), or
B3) of at least one highly branched or hyperbranched polyester of AₓB_{y} type, where x is at least 1.1 and y is at least 2.1, or
a mixture of B1) with B2) or of B2) with B3) or of B1) with B3) or of B1) with B2) and with B3), in each case with A).

2. Lightweight components according to claim 1, wherein the connection of the molded-on thermoplastic to the parent body takes place at discrete connection sites by way of perforations in the parent body, where the thermoplastic extends through these and extends over the area of the perforations.

3. Lightweight components according to claim 1, wherein the thermoplastics are selected from the group of the polyamides, vinylaromatic polymers, ASA polymers, ABS polymers, SAN polymers, POM, PPE, polypropylene or polyarylene ether sulphones or their blends.

4. Lightweight components according to claim 1, wherein the molding compositions also comprise, in addition to components A) and B),
C) from 0.001 to 75 parts by weight of a filler or reinforcing material.

5. Lightweight components according to claim 4, wherein the filler or reinforcing material comprises glass fibres.

6. Process for the production of a hybrid-form lightweight component whose external and/or internal space has reinforcing structures securely connected to the parent body and composed of molded-on thermoplastics, and having connection to the parent body at discrete connection sites, said lightweight component further comprising polymer molding compositions comprising:
A) from 99.99 to 10 parts by weight of at least one semicrystalline thermoplastic polymer and
B) from 0.01 to 50 parts by weight
B1) of at least one copolymer composed of at least one olefin with at least one methacrylate or acrylate of an aliphatic alcohol where the MFI of the copolymer B1) is not less than 100 g/10 min, or
B2) of at least one highly branched or hyperbranched polycarbonate with an OH number of from 1 to 600 mg KOH/g of polycarbonate (to DIN 53240, Part 2), or
B3) of at least one highly branched or hyperbranched polyester of AₓB_{y} type, where x is at least 1.1 and y is at least 2.1, or
a mixture of B1) with B2) or of B1) with B3) or of B2) with B3) or of B1) with B2) and with B3), in each case with A) are processed via shaping processes in a shaping mold.

7. A part comprising one or more of the lightweight components according to claim 1, said part being a part of a manufacture selected from the group consisting of motor vehicles, rail vehicles, aircraft, ships, sleds or in other means of conveyance, electrical or electronic equipment, household equipment, furniture, heaters, motor scooters, shopping trolleys, shelving, staircases, escalator steps, and manhole covers.

8. A part comprising one or more of the lightweight components according to claim 6, said part being a motor vehicle part selected from the group consisting of front ends, headlamp frames, pedestrian-protection beam, specific-purpose slam panels for engine hoods or luggage-compartment lids, front roof arches, rear roof arches, roof frames, roof modules (entire roof), sliding-roof support parts, dashboard support parts (cross car beam), steering column retainers, fire wall, pedals, pedal blocks, gear-shift blocks, A, B or C columns, B-column modules, longitudinal members, jointing elements for the connection of longitudinal members and B columns, and of transverse members, and for wheel surrounds, wheel-surround modules, crash boxes, rear ends, spare-wheel recesses, engine hoods, engine covers, engine oil sumps, gearbox oil sumps, oil modules, water-tank assembly, engine-rigidity systems (front-end rigidity system), chassis components, vehicle floor, door seals, door-seal reinforcement systems, floor reinforcement systems, seat reinforcement system, transverse seat members, tail-gates, frames, seat structures, back-rests, seat shelves, seat back-rests with and without integrated safety belt, parcel shelves, complete vehicle-door structure, joint elements for the connection of A column and transverse member, joint elements for the connection of A column, transverse member and longitudinal member, floor rigidity systems, transverse seat members, valve covers, and end-shields for generators or electric motors.

9. Method for reducing the weight of components, wherein hybrid-form lightweight components are produced from a shell-type parent body whose external and/or internal space has reinforcement structures securely connected to the parent body and composed of molded-on thermoplastics, and having connection to the parent body at discrete connection sites, where the thermoplastics are produced from polymer molding compositions comprising
A) from 99.99 to 10 parts by weight of at least one semicrystalline thermoplastic polymer and
B) from 0.01 to 50 parts by weight
B1) of at least one copolymer composed of at least one olefin with at least one methacrylate or acrylate of an aliphatic alcohol where the MFI of the copolymer B1) is not less than 100 g/10 min, or
B2) of at least one highly branched or hyperbranched polycarbonate with an OH number of from 1 to 600 mg KOH/g of polycarbonate (to DIN 53240, Part 2), or
B3) of at least one highly branched or hyperbranched polyester of AₓB_{y} type, where x is at least 1.1 and y is at least 2.1, or
a mixture of B1) with B2) or of B2) with B3) or of B1) with B3) or of B1) with B2) and with B3), in each case with A).

10. Method for reducing the weight according to claim 9, wherein the further component C) added comprises from 0.001 to 75 parts by weight of a filler or reinforcing material.

11. Method according to claim 6, wherein the shaping process comprises injection molding, melt extrusion, compression molding, stamping or blow molding.

12. Vehicles or other means of conveyance rail vehicles, aircraft, ships, sleds or motor scooters, comprising a lightweight component in hybrid form whose external and/or internal space has reinforcing structures securely connected to the parent body and composed of molded-on thermoplastics, and having connection to the parent body at discrete connection sites, said lightweight component further comprising polymer molding compositions comprising
A) from 99.99 to 10 parts by weight of at least one semicrystalline thermoplastic polymer and
B) from 0.01 to 50 parts by weight
B1) of at least one copolymer composed of at least one olefin with at least one methacrylate or acrylate of an aliphatic alcohol where the MFI of the copolymer B1) is not less than 100 g/10 min, or
B2) of at least one highly branched or hyperbranched polycarbonate with an OH number of from 1 to 600 mg KOH/g of polycarbonate (to DIN 53240, Part 2), or
B3) of at least one highly branched or hyperbranched polyester of AₓB_{y} type, where x is at least 1.1 and y is at least 2.1, or
a mixture of B1) with B2) or of B1) with B3) or of B2) with B3) or of B1) with B2) and with B3), in each case with A), and these are installed within the vehicle.
